(19) United States
(12) Patent Application Publication
(10) Pub. No.: US 2016/0290115 A1
(43) Pub. Date: Oct. 6, 2016

(54) RE-FRACTURING A FRACTURE STIMULATED SUBTERRANEAN FORMATION

(71) Applicant: HALLIBURTON ENERGY SERVICES, INC., Houston, TX (US)

(72) Inventors: Jeff T. FLEMING, Duncan, OK (US); Philip D. NGUYEN, Houston, TX (US)

(73) Assignee: Halliburton Energy Services, Inc., Houston, TX (US)

(21) Appl. No.: 15/037,754

(22) PCT Filed: Jan. 9, 2014
(86) PCT No.: PCT/US2014/010774

§ 371 Date: May 19, 2016

(51) Int. Cl. E21B 43/26; E21B 33/138; C09K 8/80; E21B 43/116; E21B 43/114; C09K 8/42; E21B 43/267; E21B 33/12

(52) U.S. Cl. CPC E21B 43/261; E21B 43/267; E21B 33/138; E21B 33/12; E21B 43/116; E21B 43/114; C09K 8/42; C09K 8/80

(57) ABSTRACT

Embodiments herein include a method comprising providing a subterranean formation having a first treatment interval comprising at least one preexisting perforation through which at least one preexisting fracture has been formed; providing a temporary sealant slurry comprising a slurry base fluid, non-degradable particulates, degradable particulates, and a stabilizing agent; placing the temporary sealant slurry into the preexisting perforation at the first treatment interval so as to at least partially seal the preexisting perforation; forming at least one new perforation; injecting a fracturing fluid comprising a fracturing base fluid and proppant particulates into the new perforation at a rate and pressure sufficient to create or enhance at least one new fracture in the formation; placing the proppant particulates into the new fracture so as to form a proppant pack therein; and degrading the degradable particulates so as to remove at least a portion of the seal in the preexisting perforation.

### BACKGROUND

The embodiments herein relate to methods and compositions for re-fracturing previously fracture stimulated subterranean formations.

Subterranean wells are often stimulated by hydraulic fracturing treatments. A liner, which may or may not be cemented in place in the subterranean formation, may include a plurality of perforations therein (e.g., by explosive charges delivered through a perforation gun, by high-speed fluid with or without a cutting agent through a jetting nozzle on a hydrojetting tool, and the like). In hydraulic fracturing treatments, a treatment fluid, often a viscous treatment fluid, may be pumped through the plurality of perforations in the liner and into a portion of a subterranean formation at a rate and pressure such that the subterranean formation breaks down and one or more fractures are formed. Typically, particulate solids, such as graded sand, are introduced into the subterranean formation in a portion of the treatment fluid and deposited into the fracture. These particulate solids, (generally known as “proppant particulates” or, simply, “proppant”) serve to prop the fracture open (e.g., keep the fracture from fully closing) after the hydraulic pressure is removed. By keeping the fracture from fully closing, the proppants aid in forming conductive paths through which produced fluids, such as hydrocarbons, may flow.

Over time, the production rate of a fracture stimulated subterranean formation may decrease or undesirable sand, water, or other materials may be produced. To restore or partially restore the productivity of the formation, new perforations and re-fracturing may be performed so as to contact new rockface (i.e., not the same rockface that was contacted upon creating the initial, or preexisting fractures).

However, the multiple perforations present along the liner through which the original fractures were created may prevent adequate fracturing of newly formed perforations for use in the re-fracturing operation. For example, the existing perforations may draw away at least a portion of the fracturing fluid from the new perforations, thereby limiting the size and or distance of desired newly formed fractures during the re-fracturing operation. Additionally, isolation of a specific treatment interval without a significant decrease in flow area may not be achievable.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 depicts an embodiment of a system configured for delivering the treatment fluids of the embodiments described herein to a downhole location.

### DETAILED DESCRIPTION

The embodiments herein relate to methods and compositions for re-fracturing previously fracture stimulated subterranean formations. Specifically, the embodiments herein relate to sealing preexisting perforations in a subterranean formation with a temporary sealant slurry prior to forming new perforations and re-fracturing the formation. After performing the re-fracturing operation, the temporary sealant slurry may be at least partially degraded or otherwise removed to restore the flow of hydrocarbons or other produced fluids to the surface.

Although some embodiments described herein are illustrated by reference to hydraulic fracturing and re-fracturing treatments, the temporary sealant slurry disclosed herein may be used in any subterranean formation operation that may benefit from a temporary sealant slurry. Such treatment operations may include, but are not limited to, a drilling operation; a stimulation operation; an acidizing operation; an acid-fracturing operation; a sand control operation; a fracturing operation; a frac-packing operation; a remedial operation; a near-wellbore consolidation operation; and any combination thereof.

Moreover, the temporary sealant slurry described herein may be used in any non-subterranean operation that may benefit from a temporary sealant slurry. Such operations may be performed in any industry including, but not limited to, oil and gas, mining, chemical, pulp and paper, aerospace, medical, automotive, and the like.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

In some embodiments, a method is provided herein including providing a subterranean formation having a first treatment interval. In some embodiments, the first treatment interval may comprise a liner. As used herein, the term “liner” may refer to any wellbore tubular, such as casing string, production string, and the like. In some embodiments, the liner may be non-cemented or may be cemented in place in the subterranean formation. The first treatment interval may comprise one or more preexisting perforations extending from the wellbore, through the liner and/or cement, and into the subterranean formation. In some embodiments, the subterranean formation may have multiple treatment intervals (e.g., the first treatment interval, a second treatment interval, a third treatment interval, and the like), each of which may comprise preexisting perforations. As used herein, the term “treatment interval” in all of its forms refers to a portion of a subterranean formation bearing hydrocarbons (e.g., a portion of the subterranean formation likely to produce hydrocarbons through fractures and into a wellbore penetrating the formation). Preexisting fractures may exist in the subterranean formation, having previously been created through the preexisting perforations (e.g., at at least a first treatment interval). A temporary sealant slurry comprising a slurry base fluid, non-degradable particulates, degradable particulates, and a stabilizing agent may be introduced into the subterranean formation and placed within the preexisting perforations so as to at least partially seal the preexisting perforation. That is, the temporary sealant slurry may at least partially prevent hydrocarbons and other produced fluid from exiting the subterranean formation and being flowed back to the surface.

The stabilizing agent in the temporary sealant slurry may serve to aggregate the degradable and non-degradable particulates together and/or to promote adhesion of the degradable and non-degradable particulates to the walls of the liner (or cement, if the liner is cemented) forming the preexisting perforations or the subterranean formation therein, thereby facilitating sealing of the preexisting perforation(s). The stabilizing agent itself may also serve to at least partially form part of the seal to the preexisting perforation(s), due to its hardenable mass or tacky nature. As used herein, the term “stabilizing agent” may generally comprise any compound that is capable of minimizing particulate migration and may include materials that set into a hardened mass and materials that set and exhibit a sticky or tacky character. As used herein, the term “tacky” in all of its forms generally refers to a substance having a nature such that it is (or may be activated to or otherwise become) somewhat sticky to the touch. In some embodiments, the stabilizing agent may be present in the temporary sealant slurry with the slurry base fluid, the non-degradable particulates, and the degradable particulates. In such embodiments, the stabilizing agent may coat at least a portion of the non-degradable particulates and/or the degradable particulates. In other embodiments, the stabilizing agent may be coated onto the non-degradable particulates for use in the temporary sealant slurry, such that the temporary sealant slurry comprises the base slurry fluid, the degradable particulates, and stabilizing agent coated non-degradable particulates. In yet other embodiments, the temporary sealant slurry may form a two-component system. The first component may comprise a first slurry base fluid, the non-degradable particulates, and the degradable particulates and the second component may comprise a second slurry base fluid and the stabilizing agent. The first component of the temporary sealant slurry may be introduced into the subterranean formation and placed in the preexisting perforation(s), followed by introduction of the second component of the temporary sealant slurry, which may coat at least a portion of the non-degradable particulates and/or the degradable particulates in the preexisting perforation(s) to facilitate sealing thereof.

After sealing the preexisting perforations, one or more new perforations may be formed in the liner in the same treatment interval as the preexisting perforations (whether at a single or first treatment interval or at multiple treatment intervals) and/or at any different treatment intervals within the formation along the length of the liner and/or in between preexisting treatment intervals. The new perforations may be created by any means known to those of skill in the art and may be of any shape and size suitable for the particular operation. For example, the new perforations may be generally circular-shaped, slot-shaped, or any other shape. As used herein, the term “slot” refers to a quadrilateral shape having two directions, where one direction is longer than the other (e.g., a rectangle). In some embodiments, the new perforations may be created by explosive charges delivered through a perforation gun or by high-speed jetting fluid comprising a jetting base fluid, and which may or may not additionally comprise a cutting agent, through a tubular member and a jetting nozzle on a hydrojetting tool. After the new perforations are formed, a fracturing fluid may be introduced therethrough at a rate and pressure sufficient to create or enhance at least one new fracture therein. In some embodiments, a hydrojetting tool may be used to form both the new perforations and the new fractures. Thereafter, the fracturing fluid may be introduced by other means into the subterranean formation, such as directly into the subterranean formation.

A fracturing fluid may be injected into the subterranean formation through the new perforation(s) so as to form the new fractures or to contact new fractures having already been formed with the hydrojetting tool, by any means known to those of skill in the art. In some embodiments, the fracturing fluid may be introduced using a hydrojetting tool having a tubular member and a jetting nozzle. In those embodiments in which the one or more new perforations is formed using a hydrojetting tool, the fluid used to create the perforations may be a jetting fluid or the fracturing fluid itself. Thus, the jetting fluid or the fracturing fluid may be used to create one or more new perforations, followed by a change in fluid expulsion pressure, if necessary, and fracturing of the formation through the new perforation(s) with the jetting fluid or the fracturing fluid. However, a hydrojetting tool may be used to inject the fracturing fluid and form new fracture(s) regardless of the method used to form the new perforation(s).

The fracturing fluid may comprise a fracturing base fluid and proppant particulates, alternatively, the fracture may be begun with a proppant-free fluid and then followed by a proppant-laden fluid. The fracturing fluid may be injected into the subterranean formation and through the new perforation(s) at a rate and pressure sufficient to create or enhance at least one new fracture and form a proppant pack therein. In other embodiments, where a hydrojetting tool and a jetting fluid are used to form both the new perforations and the new fractures, the fracturing fluid may thereafter be introduced into the subterranean formation so as to place the proppant particulates into the new fractures and form a proppant pack therein. In such embodiments, the fracturing fluid may be introduced into the subterranean formation though the annulus created between the tubular member of the hydrojetting tool and the subterranean formation. As used herein, the term “proppant pack” refers to a collection of a mass of proppant particulates within a fracture or open space in a subterranean formation. Thereafter, the non-degradable particulates in the temporary sealant slurry may be degraded so as to remove at least a portion of the seal in the preexisting perforation, thereby allowing flow or increased flow of hydrocarbons or other production fluids from the subterranean formation and to the surface through the preexisting perforations. In some embodiments, prior to injecting the fracturing fluid into the subterranean formation, the treatment interval (e.g., a first treatment interval and/or at least a second treatment interval, or multiple intervals) to be fractured through the new perforation(s) to form new fracture(s) may be isolated using packers. As used herein, the term “packer” in all of its forms refers to a device that is capable of isolating the annulus formed by the liner in a particular treatment interval, enabling controlled injection of the fracturing fluid. The packers for use in the embodiments described herein may include any packer suitable for use in a subterranean formation operation. In some embodiments the packers may include, but are not limited to, mechanical packers, tension packers, rotation packers, hydraulic packers, inflatable packers, permanent packers, cement packers, and the like.

The temporary sealant slurry, the fracturing fluid, and the jetting fluid may be collectively referred to herein as “treatment fluids.” The temporary sealant slurry may comprise a first slurry base fluid or a second slurry base fluid, the fracturing fluid may comprise a fracturing base fluid, and the jetting fluid may comprise a jetting base fluid, together which may be collectively referred to as “base fluids.” Any base fluid suitable for use in a subterranean formation operation may be used in accordance with the methods and compositions described herein. It should be noted that in those embodiments in which the temporary sealant slurry comprises a first component having a first slurry base fluid and a second component having a second slurry base fluid, the first and second slurry base fluids may be identical or different, depending on the application, the type of stabilizing agent selected, and the like. Moreover, the base fluid for use in the treatment fluids described herein may be identical or different for use in any of the embodiments.

Suitable base fluids may include, but not be limited to, oil-based fluids; aqueous-based fluids; aqueous-miscible fluids; water-in-oil emulsions; oil-in-water emulsions; and any combination thereof. Suitable oil-based fluids may include, but are not limited to, alkanes, olefins, aromatic organic compounds, cyclic alkanes, paraffins, diesel fluids, mineral oils, desulfurized hydrogenated kerosenes, and any combination thereof. Suitable aqueous-based fluids may include fresh water, saltwater (e.g., water containing one or more salts dissolved therein), brine (e.g., saturated salt water), seawater, and any combination thereof. Suitable aqueous-miscible fluids may include, but not be limited to, alcohols (e.g., methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, polyols, any derivative thereof, any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate), any in combination with an aqueous-based fluid, and any combination thereof. Suitable water-in-oil and oil-in-water emulsions may comprise any water or oil component described herein. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset therebetween. Suitable oil-in-water emulsions may have a water-to-oil ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset therebetween. It should be noted that for water-in-oil and oil-in-water emulsions, any mixture of the above may be used including the water being and/or comprising an aqueous-miscible fluid.

Generally, the water that may form part or all of a base fluid may be from any source, provided that it does not contain components that might adversely affect the stability and/or performance of the treatment fluids. In certain embodiments, the density of the aqueous fluid may be adjusted, among other purposes, to provide additional particulate (i.e., transport of the non-degradable particulates, the degradable particulates, and/or the proppant particulates) transport and suspension in the treatment fluids used in the methods of the embodiments disclosed herein. In certain embodiments, the pH of the fluid may be adjusted (e.g., by a buffer or other pH adjusting agent), among other purposes, to activate a crosslinking agent and/or to reduce the viscosity of the treatment fluid (e.g., activate a breaker, deactivate a crosslinking agent). One of ordinary skill in the art, with the benefit of this disclosure, will recognize when such density and/or pH adjustments are appropriate. In some embodiments, the pH range may preferably be from about 4 to about 11.

In some embodiments, the treatment fluids may further comprise a gelling agent. The gelling agent may be any substance (e.g., a polymeric material) capable of increasing the viscosity of the treatment fluid. In some embodiments, the gelling agent may comprise one or more polymers that have at least two molecules that are capable of forming a crosslink in a crosslinking reaction in the presence of a crosslinking agent, and/or polymers that have at least two molecules that are so crosslinked (i.e., a crosslinked gelling agent). The gelling agents may be naturally-occurring gelling agents; synthetic gelling agents; and any combination thereof. Suitable gelling agents may include, but are not limited to, a polysaccharide; a biopolymer; and/or derivatives thereof that contain one or more of these monosaccharide units: galactose, mannose, glucoside, glucose, xylose, arabinose, fructose, glucuronic acid, or pyranosyl sulfate. Examples of suitable polysaccharides may include, but are not limited to, a guar gum (e.g., hydroxyethyl guar, hydroxypropyl guar, carboxymethyl guar, carboxymethylhydroxyethyl guar, and carboxymethylhydroxypropyl guar); a cellulose; a cellulose derivative (e.g., hydroxyethyl cellulose, carboxyethylcellulose, carboxymethylcellulose, and carboxymethylhydroxyethylcellulose); xanthan; scleroglucan; succinoglycan; diutan; and any combination thereof.

Suitable synthetic polymers for use as gelling agents may include, but are not limited to, 2,2′-azobis(2,4-dimethyl valeronitrile); 2,2′-azobis(2,4-dimethyl-4-methoxy valeronitrile); polymers and copolymers of acrylamide ethyltrimethyl ammonium chloride; acrylamide; acrylamido-alkyl trialkyl ammonium salts; methacrylamido-alkyl trialkyl ammonium salts; acrylamidomethylpropane sulfonic acid; acrylamidopropyl trimethyl ammonium chloride; acrylic acid; dimethylaminoethyl methacrylamide; dimethylaminoethyl methacrylate; dimethylaminopropyl methacrylamide; dimethylaminopropylmethacrylamide; dimethyldiallylammonium chloride; dimethylethyl acrylate; fumaramide; methacrylamide; methacrylamidopropyl trimethyl ammonium chloride; methacrylamidopropyldimethyl-n-dodecylammonium chloride; methacrylamidopropyldimethyl-n-octylammonium chloride; methacrylamidopropyltrimethylammonium chloride; methacryloylalkyl trialkyl ammonium salts; methacryloylethyl trimethyl ammonium chloride; methacrylylamidopropyldimethylcetylammonium chloride; N-(3-sulfopropyl)-N-methacrylamidopropyl-N,N-dimethyl ammonium betaine; N,N-dimethylacrylamide; N-methylacrylamide; nonylphenoxypoly(ethyleneoxy)ethylmethacrylate; partially hydrolyzed polyacrylamide; poly 2-amino-2-methyl propane sulfonic acid; polyvinyl alcohol; sodium 2-acrylamido-2-methylpropane sulfonate; quaternized dimethylaminoethylacrylate; quaternized dimethylaminoethylmethacrylate; any derivative thereof; and any combination thereof. In certain embodiments, the gelling agent comprises an acrylamide/2-(methacryloyloxy)ethyltrimethylammonium methyl sulfate copolymer. In certain embodiments, the gelling agent may comprise an acrylamide/2-(methacryloyloxy)ethyltrimethylammonium chloride copolymer. In other embodiments, the gelling agent may comprise a derivatized cellulose that comprises cellulose grafted with an allyl or a vinyl monomer.

Additionally, polymers and copolymers that comprise one or more functional groups (e.g., hydroxyl, cis-hydroxyl, carboxylic acids, derivatives of carboxylic acids, sulfate, sulfonate, phosphate, phosphonate, amino, or amide groups) may be used as gelling agents.

The gelling agent may be present in the treatment fluids of the embodiments described herein in an amount sufficient to provide the desired viscosity. In some embodiments, the gelling agents (i.e., the polymeric material) may be present in an amount in the range of from a lower limit of about 5 pounds per one thousand gallons (“lb/Mgal”), 10 lb/Mgal, 15 lb/Mgal, 20 lb/Mgal, 25 lb/Mgal, 30 lb/Mgal, 35 lb/Mgal, and 40 lb/Mgal to an upper limit of about 80 lb/Mgal, 75 lb/Mgal, 70 lb/Mgal, 65 lb/Mgal, 60 lb/Mgal, 55 lb/Mgal, 50 lb/Mgal, 45 lb/Mgal, and 40 lb/Mgal of the treatment fluid. In certain embodiments, the gelling agents may be present in an amount in the range of from about 0.15% to about 2.5% by weight of the treatment fluid.

In those embodiments described herein where it is desirable to crosslink the gelling agent(s), the treatment fluid may comprise one or more crosslinking agents. The crosslinking agents may comprise a borate ion, a metal ion, or similar component that is capable of crosslinking at least two molecules of the gelling agent. Examples of suitable crosslinking agents may include, but are not limited to, a borate ion; a magnesium ion; a zirconium IV ion; a titanium IV ion; an aluminum ion; an antimony ion; a chromium ion; an iron ion; a copper ion; a magnesium ion; a zinc ion; and any combination thereof. These ions may be provided by providing any compound that is capable of producing one or more of these ions. Examples of such compounds may include, but are not limited to, ferric chloride; boric acid; disodium octaborate tetrahydrate; sodium diborate; a pentaborate; ulexite; colemanite; magnesium oxide; zirconium lactate; zirconium triethanol amine; zirconium lactate triethanolamine; zirconium carbonate; zirconium acetylacetonate; zirconium malate; zirconium citrate; zirconium diisopropylamine lactate; zirconium glycolate; zirconium triethanol amine glycolate; zirconium lactate glycolate; titanium lactate; titanium malate; titanium citrate; titanium ammonium lactate; titanium triethanolamine; titanium acetylacetonate; aluminum lactate; aluminum citrate; an antimony compound; a chromium compound; an iron compound; a copper compound; a zinc compound; and any combination thereof. In certain embodiments, the crosslinking agent may be formulated to remain inactive until it is “activated” by, among other things, certain conditions in the treatment fluid (e.g., pH, temperature, etc.) and/or interaction with some other substance. In some embodiments, the activation of the crosslinking agent may be delayed by encapsulation with a coating (e.g., a porous coating through which the crosslinking agent may diffuse slowly, or a degradable coating that degrades downhole) that delays the release of the crosslinking agent until a desired time or place. The choice of a particular crosslinking agent will be governed by several considerations that will be recognized by one skilled in the art, including but not limited to, the type of gelling agent(s) selected, the molecular weight of the gelling agent(s) selected, the conditions in the subterranean formation being treated, the safety handling requirements, the pH of the treatment fluid, the temperature of the subterranean formation, the desired delay for the crosslinking agent to crosslink the gelling agent molecules, and the like.

When included, suitable crosslinking agents may be present in the treatment fluids useful in the embodiments described herein in an amount sufficient to provide the desired degree of crosslinking between molecules of the gelling agent. In certain embodiments, the crosslinking agent may be present in the treatment fluids of the embodiments of the present disclosure in an amount in the range of from a lower limit of about 0.1 gallons per one thousand gallons (“gal/Mgal”), 1 gal/Mgal, 2 gal/Mgal, 3 gal/Mgal, 4 gal/Mgal, 5 gal/Mgal, 6 gal/Mgal, 7 gal/Mgal, 8 gal/Mgal, 9 gal/Mgal, and 10 gal/Mgal to an upper limit of about 20 gal/Mgal, 19 gal/Mgal, 18 gal/Mgal, 17 gal/Mgal, 16 gal/Mgal, 15 gal/Mgal, 14 gal/Mgal, 13 gal/Mgal, 12 gal/Mgal, 11 gal/Mgal, and 10 gal/Mgal of the treatment fluid. One of ordinary skill in the art, with the benefit of this disclosure, will recognize the appropriate amount of crosslinking agent to include in a treatment fluid of the embodiments described herein based on a number of factors, such as the temperature conditions of a particular application, the type of gelling agents selected, the molecular weight of the gelling agents, the desired degree of viscosification, the pH of the treatment fluid, and the like.

In some embodiments, the treatment fluids may further comprise an additive selected from the group consisting of a salt; a weighting agent; a fluid loss control agent; an emulsifier; a dispersion aid; a corrosion inhibitor; an emulsion thinner; an emulsion thickener; a surfactant; a lost circulation material; a foaming agent; a gas; a pH control additive; a breaker; a biocide; a stabilizer; a chelating agent; a scale inhibitor; a gas hydrate inhibitor; an oxidizer; a reducer; a friction reducer; a clay stabilizing agent; and any combination thereof.

The non-degradable particulates for use in the temporary sealant slurry and the proppant particulates for use in the fracturing fluid may be collectively referred to as “stable particulates” herein. The stable particulates may be any material that does not degrade within subterranean formation conditions over a prolonged period of time (e.g., they may degrade after the estimated useful life of the formation) or upon prolonged contact with any fluids or components used in the formation. Suitable materials for these stable particulates may include, but are not limited to, sand; bauxite; ceramic material; glass material; polymeric material (e.g., ethylene-vinyl acetate or composite materials); polytetrafluoroethylene material; nut shell pieces; a cured resinous particulate comprising nut shell pieces; seed shell pieces; a cured resinous particulate comprising seed shell pieces; fruit pit pieces; a cured resinous particulate comprising fruit pit pieces; wood; composite particulates; and any combination thereof. Suitable composite particulates may comprise a binder and a filler material, wherein suitable filler materials may include, but are not limited to, silica; alumina; fumed carbon; carbon black; graphite; mica; titanium dioxide; barite; meta-silicate; calcium silicate; kaolin; talc; zirconia; boron; fly ash; hollow glass microspheres; solid glass; and any combination thereof. Suitable stable particulates for use in conjunction with the embodiments described herein may be any known shape of material, including substantially spherical materials; fibrous materials; polygonal materials (e.g., cubic materials); and any combinations thereof.

The degradable particulates for use in the temporary sealant slurry (including the first component of the temporary sealant slurry, as described in some embodiments herein) may be any degradable material capable of degrading over time or under certain conditions (e.g., temperature, pH, and the like). Suitable examples of degradable particulates that may be used in accordance with the present disclosure may include, but are not limited to, a polysaccharide (e.g., dextran or cellulose); a chitin; a chitosan; a protein; an aliphatic polyester; a poly(lactide); a poly(glycolide); a poly(ε-caprolactone); a poly(hydroxybutyrate); a poly(anhydride); an aliphatic polycarbonate; an aromatic polycarbonate; a poly(orthoester); a poly(amino acid); a poly(ethylene oxide); a polyphosphazenes; and any combination thereof. Of these suitable degradable particulates, aliphatic polyesters and polyanhydrides may be preferred. Polyanhydride hydrolysis may proceed, in situ, via free carboxylic acid chain-ends to yield carboxylic acids as final degradation products. The degradation time can be varied over a broad range by changes in the polymer backbone. Examples of suitable polyanhydrides may include, but are not limited to, poly(adipic anhydride), poly(suberic anhydride), poly(sebacic anhydride), and poly(dodecanedioic anhydride). Other suitable examples may include, but are not limited to, poly(maleic anhydride) and poly(benzoic anhydride).

Dehydrated salts may be used in accordance with the embodiments of the present disclosure as a degradable material for forming the degradable particulates. A dehydrated salt may be suitable for use in the embodiments described herein if it will degrade over time as it hydrates. For example, a particulate solid anhydrous borate material that degrades over time may be suitable. Specific examples of particulate solid anhydrous borate materials that may be used include, but are not limited to, anhydrous sodium tetraborate (also known as anhydrous borax), and anhydrous boric acid. These anhydrous borate materials are only slightly soluble in water. However, with time and heat in a subterranean environment, the anhydrous borate materials react with the surrounding aqueous fluid and are hydrated. The resulting hydrated borate materials are highly soluble in water as compared to anhydrous borate materials and as a result degrade in the aqueous fluid. Other examples include organic or inorganic salts like acetate trihydrate.

In some embodiments, the degradable material used for forming the degradable particulates for use in some embodiments described herein may include oil-degradable polymers. Suitable oil-degradable polymers may include, but are not limited to, polyacrylics, polyamides, and polyolefins such as polyethylene, polypropylene, polyisobutylene, and polystyrene. Other suitable oil-degradable polymers include those that have a melting point which is such that the polymer will dissolve at the temperature of the subterranean formation in which it is placed such as a wax material.

Blends of certain degradable materials may also be suitable. One example of a suitable blend of materials is a mixture of poly(lactic acid) and sodium borate where the mixing of an acid and base could result in a neutral solution where this is desirable. Another example would include a blend of poly(lactic acid) and boric oxide.

In choosing the appropriate degradable material, one should consider the degradation products that will result. These degradation products should not adversely affect other operations or components and may even be selected to improve the long-term performance and/or conductivity of the subterranean formation. The choice of degradable material also may depend, at least in part, on the conditions of the formation (e.g., temperature). For instance, lactides have been found to be suitable for lower temperature formations, including those within the range of 60° F. (15.6° C.) to 150° F. (65.6° C.), and polylactides have been found to be suitable for formation temperatures above this range. Also, poly(lactic acid) may be suitable for higher temperature formations. Some stereoisomers of poly(lactide) or mixtures of such stereoisomers may be suitable for even higher temperature applications.

In some embodiments, a preferable result is achieved if the degradable material degrades slowly over time as opposed to instantaneously. The slow degradation of the degradable material, in situ, helps to ensure sealing of the preexisting perforations during re-fracturing operations.

The stable particulates (i.e., the non-degradable particulates and the proppant particulates) and the non-degradable particulates, collectively referred to herein as “particulates,” for use in the methods of the present disclosure may be of any size and shape combination known in the art as suitable for use in a fracturing operation. Generally, where the chosen particulate is substantially spherical, suitable particulates may have a size in the range of from a lower limit of about 2 mesh, 10 mesh, 20 mesh, 30 mesh, 40 mesh, 50 mesh, 60 mesh, 70 mesh, 80 mesh, 90 mesh, 100 mesh, 110 mesh, 120 mesh, 130 mesh, 140 mesh, 150 mesh, 160 mesh, 170 mesh, 180 mesh, 190 mesh, and 200 mesh to an upper limit of about 400 mesh, 390 mesh, 380 mesh, 370 mesh, 360 mesh, 350 mesh, 340 mesh, 330 mesh, 320 mesh, 310 mesh, 300 mesh, 290 mesh, 280 mesh, 270 mesh, 260 mesh, 250 mesh, 240 mesh, 230 mesh, 220 mesh, 210 mesh, and 200 mesh, U.S. Sieve Series, or even higher. In some embodiments of the present disclosure, the particulates may have a size in the range of from about 8 to about 120 mesh, U.S. Sieve Series. A major advantage of using this method is there is no need for the particulates to be sieved or screened to a particular or specific particle mesh size or particular particle size distribution, but rather a wide or broad particle size distribution can be used.

In some embodiments of the present disclosure, it may be desirable to use substantially non-spherical particulates (i.e., degradable particulates, non-degradable particulates, and proppant particulates). Suitable substantially non-spherical particulates may be cubic, polygonal, fibrous, or any other non-spherical shape. Such substantially non-spherical particulates may be, for example, cubic-shaped; rectangular-shaped; rod-shaped; ellipse-shaped; cone-shaped; pyramid-shaped; cylinder-shaped; and any combination thereof. That is, in embodiments wherein the particulates are substantially non-spherical, the aspect ratio of the material may range such that the material is fibrous to such that it is cubic, octagonal, or any other configuration. Substantially non-spherical particulates are generally sized such that the longest axis is from about 0.02 inches (“in”), 0.03 in, 0.04 in, 0.05 in, 0.06 in, 0.07 in, 0.08 in, 0.09 in, 0.1 in, 0.11 in, 0.12 in, 0.13 in, 0.14 in, and 0.15 in to an upper limit of about 0.3 in, 0.29 in, 0.28 in, 0.27 in, 0.26 in, 0.25 in, 0.24 in, 0.23 in, 0.22 in, 0.21 in, 0.2 in, 0.19 in, 0.18 in, 1.17 in, 0.16 in, and 0.15 in length. In other embodiments, the longest axis is from about 0.05 inches to about 0.2 inches in length. In one embodiment, the substantially non-spherical particulates may be cylindrical and have an aspect ratio of about 1.5 to about 1, and about 0.08 inches in diameter and about 0.12 inches in length. In another embodiment, the substantially non-spherical particulates may be cubic having sides of about 0.08 inches in length. The use of substantially non-spherical particulates may be desirable in some embodiments described herein because, among other things, they may provide a lower rate of settling when slurried into a fluid, or may be better suited for placement in the preexisting or new perforations and/or new fractures described in some embodiments herein.

In those embodiments where a jetting fluid is used through a hydrojetting tool to form the new perforations and/or the new perforations and the new fractures, the jetting fluid may comprise a jetting base fluid and, optionally a cutting agent. Any suitable material sufficiently robust to aid in formation of the new perforations and/or the new fractures may be used as a cutting agent. In some embodiments, any of the stable particulates and/or the degradable particulates described herein that can aid in forming the new perforations and/or the new fractures may be used as a cutting agent.

In some embodiments, the non-degradable particulates may be present in the temporary sealant slurry, or in the first component of the temporary sealant slurry in an amount in the range of from a lower limit of about 0.01%, 5%, 10%, 15%, 20%, 25%, 30%, 35%, 40%, 45%, and 50% to an upper limit of about 100%, 95%, 90%, 85%, 80%, 75%, 70%, 65%, 60%, 55%, and 50% by weight of the temporary sealant slurry. In some embodiments, the degradable particulates may be present in the temporary sealant slurry, or in the first component of the temporary sealant slurry in an amount in the range of from a lower limit of about 0.01%, 5%, 10%, 15%, 20%, 25%, 30%, 35%, 40%, 45%, and 50% to an upper limit of about 100%, 95%, 90%, 85%, 80%, 75%, 70%, 65%, 60%, 55%, and 50% by weight of the temporary sealant slurry. In some embodiments, the proppant particulates may be present in the fracturing fluid in an amount in the range of from a lower limit of about 0.01%, 5%, 10%, 15%, 20%, 25%, 30%, 35%, 40%, 45%, and 50% to an upper limit of about 100%, 95%, 90%, 85%, 80%, 75%, 70%, 65%, 60%, 55%, and 50% by weight of the temporary sealant slurry. In some embodiments, the cutting agents may be present in the jetting fluid in an amount in the range of from a lower limit of about 0.01%, 5%, 10%, 15%, 20%, 25%, 30%, 35%, 40%, 45%, and 50% to an upper limit of about 100%, 95%, 90%, 85%, 80%, 75%, 70%, 65%, 60%, 55%, and 50% by weight of the jetting fluid.

Stabilizing agents may be included in the temporary sealant slurries of the present disclosure (including the second component of the temporary sealant slurry, in some embodiments) to facilitate aggregation of the non-degradable particulates and the degradable particulates to one another and/or to the liner or subterranean formation within a preexisting perforation. The stabilizing agents may also facilitate sealing of a preexisting formation to permit a re-fracturing operation to be performed. In some preferred embodiments, the stabilizing agent is an aqueous tackifying or an emulsified resin having an aqueous external layer.

Suitable stabilizing agents for use in the present disclosure may include, but are not limited to, a non-aqueous tackifying agent; an aqueous tackifying agent; a silyl-modified polyamide compound; a binder; a curable resin composition (e.g., a composition capable of curing to form hardened substance); and any combination thereof. Stabilizing agents may be applied on-the-fly by including the stabilizing agent in the temporary sealant slurry at the well site, directly prior to pumping the temporary sealant slurry into the formation, or may be applied to coat the non-degradable particulates or degradable particulates at the well site, directly before including them into the temporary sealant slurry to be pumped into the formation. As used herein, the term “on-the-fly” refers to performing an operation during a subterranean treatment that does not require stopping normal operations.

Non-aqueous tackifying agents suitable for use in the temporary sealant slurries of the present disclosure may comprise any compound that, when in liquid form or in a solvent solution, will form a non-hardening coating upon a particulate. A particularly preferred group of non-aqueous tackifying agents may comprise polyamides that are liquids or in solution at the temperature of the subterranean formation such that they are, by themselves, non-hardening when introduced into the subterranean formation. A particularly preferred product may be a condensation reaction product comprised of polyacid(s) and a polyamine. Such products may include compounds such as mixtures of C₃₆ dibasic acids containing some trimer and higher oligomers and also small amounts of monomer acids that are reacted with polyamines. Other polyacids may include trimer acids, synthetic acids produced from fatty acids, maleic anhydride, acrylic acid, and the like. Additional compounds which may be used as non-aqueous tackifying agents may include liquids and solutions of, for example, polyesters, polycarbonates and polycarbamates, natural resins such as shellac, and the like.

Non-aqueous tackifying agents suitable for use in the embodiments disclosed herein may be used such that they form a non-hardened coating, or may be combined with a multifunctional material capable of reacting with the non-aqueous tackifying compound to form a hardened coating. A “hardened coating” as used herein means that the reaction of the non-aqueous tackifying agent with the multifunctional material will result in a substantially non-flowable reaction product that exhibits a higher compressive strength in a consolidated agglomerate than the non-aqueous tackifying agent alone. In this instance, the non-aqueous tackifying agent may function similarly to a hardenable resin. Multifunctional materials suitable for use in the present disclosure may include, but are not limited to, an aldehyde (e.g., formaldehyde); a dialdehyde (e.g., glutaraldehyde, hemiacetals or aldehyde releasing compounds); a diacid halide; a dihalide (e.g., dichlorides and dibromides); a polyacid anhydride (e.g., citric acid, epoxides, furfuraldehyde, glutaraldehyde or aldehyde condensates); and any combination thereof. In some embodiments, the multifunctional material may be mixed with the non-aqueous tackifying agent in an amount of from a lower limit of about 0.01%, 0.5%, 0.1%, 0.5%, 1%, 5%, 10%, and 15% to an upper limit of about 50%, 45%, 40%, 35%, 30%, 25%, 20%, and 15% by weight of the non-aqueous tackifying agent. In other embodiments, the multifunctional material may be mixed with the non-aqueous tackifying agent in an amount of from about 0.5% to about 1% by weight of the non-aqueous tackifying agent.

Solvents suitable for use with the non-aqueous tackifying agents may include any solvent that is compatible with the non-aqueous tackifying agent and achieves the desired viscosity effect. The solvents that can be used in the embodiments disclosure herein may preferably include those having high flash points (most preferably above about 125° F. (51.7° C.)). Examples of solvents suitable for use in the embodiments herein with the non-aqueous tackifying agents may include, but are not limited to, butylglycidyl ether; dipropylene glycol methyl ether; butyl bottom alcohol; dipropylene glycol dimethyl ether; diethyleneglycol methyl ether; ethyleneglycol butyl ether; methanol; butyl alcohol; isopropyl alcohol; diethyleneglycol butyl ether; propylene carbonate; d′limonene; 2-butoxy ethanol; butyl acetate; furfuryl acetate; butyl lactate; dimethyl sulfoxide; dimethyl formamide; fatty acid methyl ester; and any combination thereof. It is within the ability of one skilled in the art, with the benefit of this disclosure, to determine whether a solvent is needed to achieve a viscosity suitable to the subterranean conditions and, if so, how much.

Suitable aqueous tackifying agents for use as the stabilizing agent may be mixed in the temporary sealant slurry or may be intentionally coated at least partially upon the surface of the non-degradable particulates or degradable particulates. Generally, suitable aqueous tackifying agents are not significantly tacky when mixed with or coated onto the non-degradable or degradable particulates, but are capable of being “activated” (that is destabilized, coalesced and/or reacted) to transform the compound into a sticky, tackifying compound at a desirable time. Such activation may occur before, during, or after the aqueous tackifying agent is placed in the subterranean formation. In some embodiments, a pretreatment may be first contacted with the surface of the non-degradable particulate to prepare it to be coated with an aqueous tackifying agent. Suitable aqueous tackifying agents may generally be charged polymers that comprise compounds that, when in an aqueous solvent or solution, will form a non-hardening coating (by itself or with an activator) and, when placed on the non-degradable and/or degradable particulate, will increase the continuous critical re-suspension velocity thereof when contacted by a stream of aqueous fluid.

Examples of aqueous tackifying agents suitable for use in the embodiments herein may include, but are not limited to, an acrylic acid polymer; an acrylic acid ester polymer; an acrylic acid derivative polymer; an acrylic acid homopolymers; an acrylic acid ester homopolymer (e.g., poly(methyl acrylate), poly(butyl acrylate), and poly(2-ethylhexyl acrylate)); an acrylic acid ester co-polymer; a methacrylic acid derivative polymer; a methacrylic acid homopolymer; a methacrylic acid ester homopolymer (e.g., poly(methyl methacrylate), poly(butyl methacrylate), and poly(2-ethylhexyl methacrylate)); an acrylamido-methyl-propane sulfonate polymer; an acrylamido-methyl-propane sulfonate derivative polymer; an acrylamido-methyl-propane sulfonate copolymer; an acrylic acid/acrylamido-methyl-propane sulfonate copolymer; and any combination thereof.

Silyl-modified polyamide compound may be used as the stabilizing agent in some embodiments described herein. The silyl-modified polyamide compounds suitable for use as a stabilizing agent in the methods of the present disclosure may be described as substantially self-hardening compositions that are capable of at least partially adhering the non-degradable and/or degradable particulates described herein in the unhardened state, and that are further capable of self-hardening into a substantially non-tacky state. Such silyl-modified polyamide compounds may be based, for example, on the reaction product of a silating compound with a polyamide or a mixture of polyamides. The polyamide or mixture of polyamides may be one or more polyamide intermediate compounds obtained, for example, from the reaction of a polyacid (e.g., diacid or higher) with a polyamine (e.g., diamine or higher) to form a polyamide polymer with the elimination of water. Other suitable silyl-modified polyamides and methods of making such compounds are described in U.S. Pat. No. 6,439,309, the entire disclosure of which is herein incorporated by reference.

Binders suitable for use as the stabilizing agent of the embodiments described herein may generally comprise a heterocondensate of (1) a hydrolysable silicon compound having at least one non-hydrolysable organic radical without polymerizable group and (2) a metal and/or boron compound. Such binders may be prepared by hydrolyzing (1), above, with water; adding (2), above, to the resultant reaction mixture after the water in the reaction mixture is substantially consumed; and, optionally, adding an organic binder component to the heterocondensate and/or a precursor thereof.

In addition, binders suitable for use in the embodiments described herein may generally comprise 1) a hydrolysate or heterocondensate of at least one hydrolysable silicon compound and at least one metal, phosphorus or boron compound, the metal being selected from Al, Ge, Sn, Pb, Ti, Mg, Li, V, Nb, Ta, Zr and Hf; 2) an organic polymerizable or polycondensable monomer or oligomer; and, 3) a buffer, so that the pH of the buffered binder is in the range from 2 to 7, and optionally a complexing agent, if appropriate, the at least one hydrolysable silicon compound comprising one or more hydrolysable silicon compounds having at least one nonhydrolysable group or oligomers thereof. Such binders are suitable for consolidating bulk or loose substrates.

Other binders suitable for using the present disclosure may generally comprise:
(I) a consolidant comprising a hydrolyzate or precondensate of
   (a) at least one organosilane of the general formula (I):

RₙSiX₄₋ₙ (I)
in which the R radicals are the same or different and are each hydrolytically non-removable groups, the X radicals are the same or different and are each hydrolytically removable groups or hydroxyl groups and n is 1, 2 or 3,
(b) optionally at least one hydrolyzable silane of the general formula (II)

SiX₄ (II)
in which the X radicals are each as defined above, and
(c) at least one metal compound of the general formula (III)

MXₐ (III)
in which M is a metal of main groups I to VIII or of transition groups II to VIII of the Periodic Table of the Elements including boron, X is as defined in formula (I), where two X groups may be replaced by one oxo group, and a corresponds to the valence of the element,
where the molar ratio of silicon compounds used to metal compounds used is in the range from 8000:1 to 8:1,
is infiltrated or injected into the geological formation and,
(II) the consolidant is cured under elevated pressure and elevated temperature,
where the consolidant, in the case that it is used to change the wetting behavior of the formation, also comprises an oleophobic and hydrophobic component. Comprehensive investigations have shown that these consolidants are not decomposed even in autoclaves at high pressure and high temperature even over a prolonged period, and also still form a stable bond under these conditions. In the case of use of a wetting-regulating consolidation variant, it was shown that the wetting behavior established is retained after a hydrothermal treatment in corrosive medium. The consolidation also reduces the porosity only to a slight degree.

Curable resins suitable for use as the stabilizing agent in some embodiments described herein may be any resins known in the art that are capable of forming a hardened, consolidated mass. Some suitable curable resins may include, but are not limited to, a two component epoxy based resins; a novolak resin; a polyepoxide resin; a phenol-aldehyde resin; a urea-aldehyde resin; a urethane resin; a phenolic resin; a furan resin; a furan/furfuryl alcohol resin; a phenolic/latex resin; a phenol formaldehyde resin; a polyester resin; a polyester resin hybrid; a polyester resin copolymer; a polyurethane resin; a polyurethane resin hybrid; a polyurethane resin copolymer; an acrylate resin; a silicon-based resin; and any combination thereof. Some suitable curable resins, such as epoxy resins, may be cured with an internal catalyst or activator so that when pumped down hole, they may be cured using only time and temperature. Other suitable curable resins, such as furan resins generally require a time-delayed catalyst or an external catalyst to help activate the polymerization of the resins if the cure temperature is low (i.e., less than 250° F. (121.1° C.)), but will cure under the effect of time and temperature if the formation temperature is above about 250° F. (121.1° C.), preferably above about 300° F. (148.9° C.). It is within the ability of one skilled in the art, with the benefit of this disclosure, to select a suitable curable resin for use in embodiments described herein and to determine whether a catalyst is required to trigger curing.

Any solvent that is compatible with the curable resin and achieves the desired viscosity effect is suitable for use in the embodiments described herein.

Preferred solvents include those listed above in connection with tackifying agents. It is within the ability of one skilled in the art, with the benefit of this disclosure, to determine whether and how much solvent is needed to achieve a suitable viscosity.

Generally, the stabilizing agent may be added in any amount capable of associating with the particulates in the temporary sealant slurry, permitting coating onto the non-degradable particulates and/or degradable particulates, and/or facilitating sealing of the preexisting perforations described in some embodiments herein. In some embodiments, the stabilizing agent may be present in an amount of from a lower limit of about 0.1%, 0.25%, 0.5%, 0.75%, 1%, 1.25%, 1.5%, 1.75%, 2%, 2.25%, and 2.5% to an upper limit of about 5%. 4.75%, 4.5%, 4.25%, 4%, 3.75%, 3.5%, 3.25%, 3%, 2.75%, and 2.5% by weight of the combined degradable and non-degradable particulates. In those embodiments where the temporary sealant slurry comprises a first and second component, the first component comprising a first slurry base fluid, non-degradable particulates, and degradable particulates, and a second component comprising a second slurry base fluid and a stabilizing agent, the amount of stabilizing agent included in the second component may be determined based on the weight of the combined degradable and non-degradable particulates present in the first component of the temporary sealant slurry.

In various embodiments, systems configured for delivering the treatment fluids (i.e., the temporary sealant slurry and the fracturing fluid) described herein to a downhole location are described. In various embodiments, the systems can comprise a pump fluidly coupled to a tubular, the tubular containing the treatment fluids described herein. It will be appreciated that while the system described below may be used for delivering either or both of the temporary sealant slurry and the fracturing fluid, each treatment fluid is delivered separately into the subterranean formation.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluids to a subterranean formation at or above a fracture gradient of the subterranean formation, but it may also be used in cases where fracturing is not desired. In some embodiments, the high pressure pump may be capable of fluidly conveying particulate matter, such as the non-degradable particulates, the degradable particulates, and the proppant particulates described in some embodiments herein, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluids to the high pressure pump. In such embodiments, the low pressure pump may “step up” the pressure of the treatment fluids before reaching the high pressure pump.

In some embodiments, the systems described herein can further comprise a mixing tank that is upstream of the pump and in which the treatment fluids are formulated. In various embodiments, the pump (e.g., a low pressure pump, a high pressure pump, or a combination thereof) may convey the treatment fluids from the mixing tank or other source of the treatment fluids to the tubular. In other embodiments, however, the treatment fluids may be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluids may be drawn into the pump, elevated to an appropriate pressure, and then introduced into the tubular for delivery downhole.

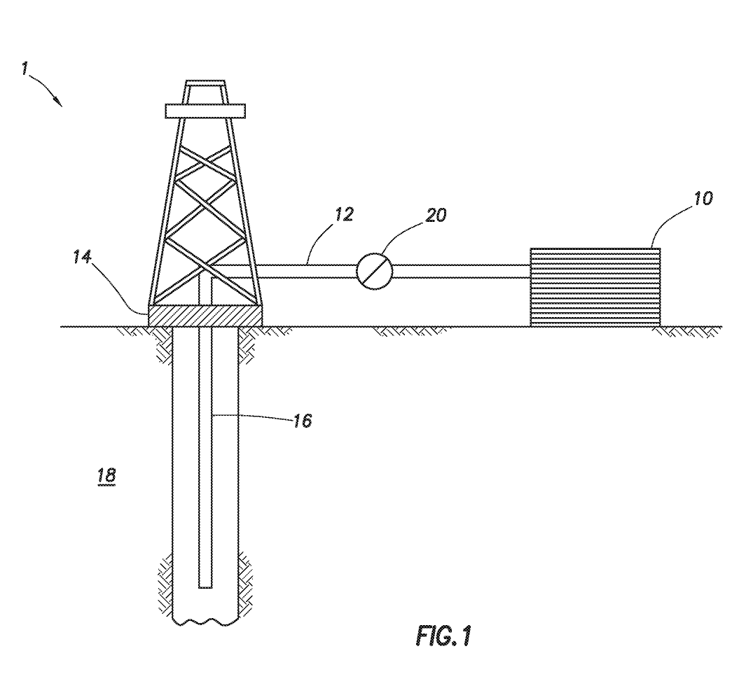

FIG. 1 shows an illustrative schematic of a system that can deliver the treatment fluids of the present disclosure to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which the treatment fluids of the embodiments herein may be formulated. The treatment fluids may be conveyed via line 12 to wellhead 14, where the treatment fluids enter tubular 16, tubular 16 extending from wellhead 14 into subterranean formation 18. Upon being ejected from tubular 16, the treatment fluids may subsequently penetrate into subterranean formation 18. Pump 20 may be configured to raise the pressure of the treatment fluids to a desired degree before introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments disclosed herein include:

A. A method comprising: providing a temporary sealant slurry comprising a slurry base fluid, non-degradable particulates, degradable particulates, and a stabilizing agent; placing the temporary sealant slurry into an at least one preexisting perforation at a first treatment interval within a subterranean formation so as to at least partially seal the at least one preexisting perforation; wherein the first treatment interval comprises at least one preexisting perforation through which at least one preexisting fracture has been formed in the subterranean formation; forming at least one new perforation; injecting a fracturing fluid comprising a fracturing base fluid and proppant particulates into the at least one new perforation at a rate and pressure sufficient to create or enhance at least one new fracture in the subterranean formation; placing the proppant particulates into the at least one new fracture so as to form a proppant pack therein; and degrading the degradable particulates so as to remove at least a portion of the seal in the preexisting perforation.

B. A method comprising: providing a temporary sealant slurry comprising a slurry base fluid, non-degradable particulates, degradable particulates, and a stabilizing agent; placing the temporary sealant slurry into an at least one preexisting perforation at a first treatment interval within a subterranean formation so as to at least partially seal the at least one preexisting perforation; wherein the first treatment interval comprises at least one preexisting perforation through which at least one preexisting fracture has been formed in the subterranean formation; forming at least one new perforation and at least one new fracture therethrough with a jetting fluid through a hydrojetting tool comprising a tubular member and a jetting nozzle; introducing a fracturing fluid comprising a fracturing base fluid and proppant particulates into the subterranean formation; placing the proppant particulates into the at least one new fracture so as to form a proppant pack therein; and, degrading the degradable particulates so as to remove at least a portion of the seal in the preexisting perforation.

C. A method comprising: providing a two-component temporary sealant slurry, wherein the first component comprises a first slurry base fluid, degradable particulates, and non-degradable particulates, and wherein the second component comprises a second slurry base fluid and a stabilizing agent; placing the first component of the temporary sealant slurry into an at least one preexisting perforation at a first treatment interval within a subterranean formation; wherein the first treatment interval comprises at least one preexisting perforation through which at least one preexisting fracture has been formed in the subterranean formation; placing the second component of the temporary sealant slurry into the at least one preexisting perforation, thereby at least partially sealing the preexisting perforation; forming at least one new perforation; injecting a fracturing fluid comprising a fracturing base fluid and proppant particulates into the at least one new perforation at a rate and pressure sufficient to create or enhance at least one new fracture in the subterranean formation; placing the proppant particulates into the at least one new fracture so as to form a proppant pack therein; and degrading the degradable particulates so as to remove at least a portion of the seal in the preexisting perforation.

Each of embodiments A, B, and C may have one or more of the following additional elements in any combination:

Element 1: Wherein the temporary sealant slurry and/or the fracturing fluid further comprises a gelling agent.

Element 2: Wherein the at least one new perforation is formed in the first treatment interval and/or in at least a second treatment interval.

Element 3: Further comprising isolating the first treatment interval and/or the second treatment interval comprising the at least one new perforation with packers prior to the step of: injecting a fracturing fluid comprising a fracturing base fluid and proppant particulates into the at least one new perforation at a rate and pressure sufficient to create or enhance at least one fracture in the subterranean formation.

Element 4: Further comprising isolating the first treatment interval and/or the second treatment interval comprising the at least one new perforation with packers prior to the step of: introducing a fracturing fluid comprising a fracturing base fluid and proppant particulates into the subterranean formation.

Element 5: Wherein the at least one new perforation is formed using an explosive charge or a hydrojetting tool comprising a tubular member and a jetting nozzle.

Element 6: Further comprising providing a hydrojetting tool comprising a tubular member and a jetting nozzle, wherein the fracturing fluid is injected into the at least one new perforation through the hydrojetting tool.

Element 7: Wherein the degradable particulates are selected from the group consisting of a polysaccharide; a chitin; a chitosan; a protein; an aliphatic polyester; a poly(lactide); a poly(glycolide); a poly(ε-caprolactone); a poly(hydroxybutyrate); a poly(anhydride); an aliphatic polycarbonate; an aromatic polycarbonate; a poly(orthoester); a poly(amino acid); a poly(ethylene oxide); a polyphosphazenes; and any combination thereof.

Element 8: Wherein the non-degradable particulates are coated with the stabilizing agent.

Element 9: Wherein an annulus is created between the tubular member of the hydrojetting tool and the subterranean formation, and wherein the fracturing fluid is introduced into the subterranean formation through the annulus.

Element 10: Further comprising providing a hydrojetting tool comprising a tubular member and a jetting nozzle, wherein an annulus is created between the tubular member of the hydrojetting tool and the subterranean formation, and wherein the fracturing fluid is injected into the at least one new perforation through the hydrojetting tool.

Element 11: Wherein the fracturing fluid is introduced into the subterranean formation through the hydrojetting tool.

Element 12: Wherein the degradable particulates are coated with the stabilizing agent.

By way of non-limiting example, exemplary combinations applicable to A, B, C include: A with 1, 3, and 10; A with 2 and 12; B with 4, 9, and 11; B with 6, 7, and 12; C with 3 and 10; C with 5, 8, and 9.

Therefore, the embodiments disclosed herein are well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
providing a temporary sealant slurry comprising a slurry base fluid, non-degradable particulates, degradable particulates, and a stabilizing agent;
placing the temporary sealant slurry into an at least one preexisting perforation at a first treatment interval within a subterranean formation so as to at least partially seal the at least one preexisting perforation;
wherein the first treatment interval comprises at least one preexisting perforation through which at least one preexisting fracture has been formed in the subterranean formation;
forming at least one new perforation;
injecting a fracturing fluid comprising a fracturing base fluid and proppant particulates into the at least one new perforation at a rate and pressure sufficient to create or enhance at least one new fracture in the subterranean formation;
placing the proppant particulates into the at least one new fracture so as to form a proppant pack therein; and
degrading the degradable particulates so as to remove at least a portion of the seal in the preexisting perforation.

2. The method of claim 1, wherein the temporary sealant slurry and/or the fracturing fluid further comprises a gelling agent.

3. The method of claim 1, wherein the at least one new perforation is formed in the first treatment interval and/or in at least a second treatment interval.

4. The method of claim 3, further comprising isolating the first treatment interval and/or the second treatment interval comprising the at least one new perforation with packers prior to the step of: injecting a fracturing fluid comprising a fracturing base fluid and proppant particulates into the at least one new perforation at a rate and pressure sufficient to create or enhance at least one fracture in the subterranean formation.

5. The method of claim 1, wherein the at least one new perforation is formed using an explosive charge or a hydrojetting tool comprising a tubular member and a jetting nozzle.

6. The method of claim 1, further comprising providing a hydrojetting tool comprising a tubular member and a jetting nozzle, wherein the fracturing fluid is injected into the at least one new perforation through the hydrojetting tool.

7. The method of claim 1, wherein the degradable particulates are selected from the group consisting of a polysaccharide; a chitin; a chitosan; a protein; an aliphatic polyester; a poly(lactide); a poly(glycolide); a poly(ε-caprolactone); a poly(hydroxybutyrate); a poly(anhydride); an aliphatic polycarbonate; an aromatic polycarbonate; a poly(orthoester); a poly(amino acid); a poly(ethylene oxide); a polyphosphazenes; and any combination thereof.

8. The method of claim 1, wherein the non-degradable particulates are coated with the stabilizing agent.

9. A method comprising:
providing a temporary sealant slurry comprising a slurry base fluid, non-degradable particulates, degradable particulates, and a stabilizing agent;
placing the temporary sealant slurry into an at least one preexisting perforation at a first treatment interval within a subterranean formation so as to at least partially seal the at least one preexisting perforation;
wherein the first treatment interval comprises at least one preexisting perforation through which at least one preexisting fracture has been formed in the subterranean formation;
forming at least one new perforation and at least one new fracture therethrough with a jetting fluid through a hydrojetting tool comprising a tubular member and a jetting nozzle;
introducing a fracturing fluid comprising a fracturing base fluid and proppant particulates into the subterranean formation;
placing the proppant particulates into the at least one new fracture so as to form a proppant pack therein; and
degrading the degradable particulates so as to remove at least a portion of the seal in the preexisting perforation.

10. The method of claim 9, wherein an annulus is created between the tubular member of the hydrojetting tool and the subterranean formation, and wherein the fracturing fluid is introduced into the subterranean formation through the annulus.

11. The method of claim 9, wherein the at least one new perforation is formed in the first treatment interval and/or in at least a second treatment interval.

12. The method of claim 11, further comprising isolating the first treatment interval and/or the second treatment interval comprising the at least one new perforation with packers prior to the step of: introducing a fracturing fluid comprising a fracturing base fluid and proppant particulates into the subterranean formation.

13. The method of claim 9, wherein the fracturing fluid is introduced into the subterranean formation through the hydrojetting tool.

14. The method of claim 9, wherein the degradable particulates are selected from the group consisting of a polysaccharide; a chitin; a chitosan; a protein; an aliphatic polyester; a poly(lactide); a poly(glycolide); a poly(ε-caprolactone); a poly(hydroxybutyrate); a poly(anhydride); an aliphatic polycarbonate; a poly(orthoester); a poly(amino acid); a poly(ethylene oxide); a polyphosphazene; a dehydrated salt; a polyacrylic; a polyamide; a polyolefin; and any combination thereof.

15. The method of claim 9, wherein the non-degradable particulates are coated with the stabilizing agent.

16. A method comprising:
providing a two-component temporary sealant slurry, wherein the first component comprises a first slurry base fluid, degradable particulates, and non-degradable particulates, and wherein the second component comprises a second slurry base fluid and a stabilizing agent;
placing the first component of the temporary sealant slurry into an at least one preexisting perforation at a first treatment interval within a subterranean formation;
wherein the first treatment interval comprises at least one preexisting perforation through which at least one preexisting fracture has been formed in the subterranean formation;
placing the second component of the temporary sealant slurry into the at least one preexisting perforation, thereby at least partially sealing the preexisting perforation;
forming at least one new perforation;
injecting a fracturing fluid comprising a fracturing base fluid and proppant particulates into the at least one new perforation at a rate and pressure sufficient to create or enhance at least one new fracture in the subterranean formation;
placing the proppant particulates into the at least one new fracture so as to form a proppant pack therein; and
degrading the degradable particulates so as to remove at least a portion of the seal in the preexisting perforation.

17. The method of claim 16, wherein the at least one new perforation is formed in the first treatment interval and/or in at least a second treatment interval.

18. The method of claim 17, further comprising isolating the first treatment interval and/or the second treatment interval comprising the at least one new perforation with packers prior to the step of: injecting a fracturing fluid comprising a fracturing base fluid and proppant particulates into the at least one new perforation at a rate and pressure sufficient to create or enhance at least one new fracture in the subterranean formation.

19. The method of claim 16, wherein the at least one new perforation is formed using an explosive charge or a hydrojetting tool comprising a tubular member and a jetting nozzle.

20. The method of claim 16, wherein the fracturing fluid is injected into the at least one new perforation through a hydrojetting tool comprising a tubular member and a jetting nozzle.
